(19) United States
(12) Patent Application Publication
(10) Pub. No.: US 2006/0008780 A1
(43) Pub. Date: Jan. 12, 2006

(54) Hair educational tool

(75) Inventor: Kam Chiu Pang, Hong Kong (CN)

Correspondence Address: NEAL, GERBER, & EISENBERG, SUITE 2200, 2 NORTH LASALLE STREET, CHICAGO, IL, 60602, US

(73) Assignee: Pivot Point International, Inc., Evanston, IL (US)

(21) Appl. No.: 10/501,967

(22) PCT Filed: Jan. 22, 2003
(86) PCT No.: PCT/US03/01807

§ 371 Date: Jul. 6, 2005

(30) Foreign Application Priority Data
Jan. 23, 2002 (CN) 02200978.7

(51) Int. Cl. G09B 19/10

(52) U.S. Cl. 434/94

(57) ABSTRACT

This creation is a kind of appliance for haircut teaching. It mainly consists of hair wig (1) and head form (2). On the head form (2), there is a fixing part along hairline (3); on the hair wig (1), there is another fixing part (3) corresponding to the one on the head form. At the bottom of the head form, there is a support (4). When practicing, the hair wig (1) and the head form (2) will be connected together to be a complete mannequin. After practicing, the head form will still be remained for next use. The positive effect of this creation is: convenient to use, beneficial for resource economy and environmental protection, easy to produce and promote.

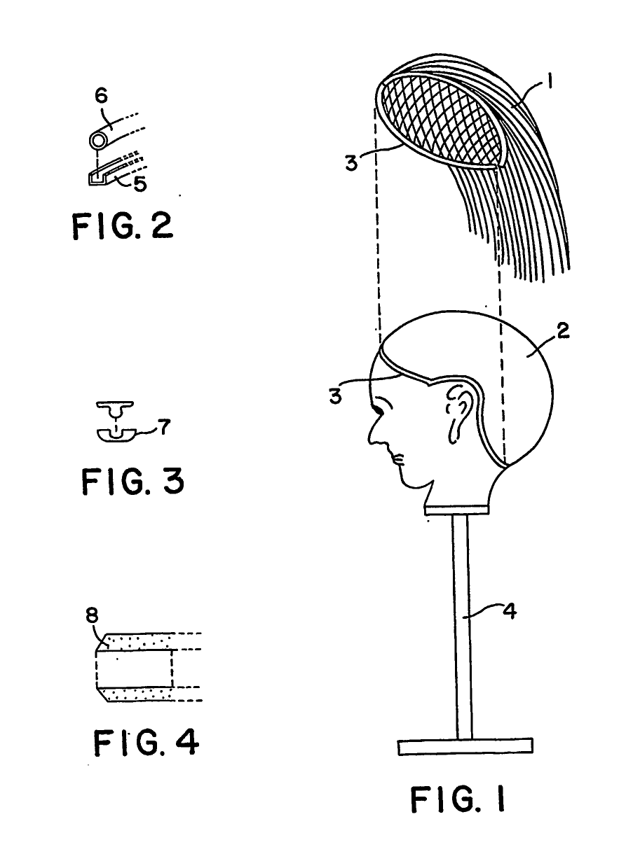

### FIELD OF THE INVENTION

This practical creation is a sort of appliance for haircut teaching.

### TECHNICAL BACKGROUND

This appliance is an improvement of the existing haircut teaching mannequin with hair planted in the head form. After use, the mannequin is thrown away, causing a lot of material waste and heavy environmental pollution. This practical creation aims to design a sort of haircut teaching tool that can be used over and over, to avoid waste.

### DETAILS OF THIS INVENTION

This practical creation is carried out in this way: This creation mainly consists of hair wig and head form. On the head form, there is a fixing part along hairline; on the hair wig, there is another fixing part corresponding to the one on the head form. At the bottom of the head form, there is a support. When practicing, the hair wig and head form will be connected together to be a complete mannequin. After practicing, the head form will still be remained for next use.

The fixing part of the head form mentioned above is a concave groove along the hairline, and the fixing part on the hair wig mentioned above is a convex ridge along the hairline. When the convex ridge is pressed in to the concave groove, hair wig is connected with head form.

The fixing part of the head form mentioned above is some snap fasteners along the hairline, and the fixing part on the hair wig mentioned above is the corresponding sets to the snap fasteners along the hairline. Hair wig and head form connects to each other by fixing the two parts of snap fasteners.

The fixing part of the head form mentioned above is a piece of nylon agraffe along the hairline, and the fixing part of the wig mentioned above is the corresponding set to the agraffe along the hairline. Hair wig and head form connects to each other by fixing the two parts of snap fasteners.

The mentioned head form is made of PCV.

The positive effect of this creation is: convenient to use, beneficial for resource economy and environmental protection, easy to produce and promote.

### DIRECTIONS OF THE ATTACHED DRAWING

Drawing 1 is the building structure of this practical creation.

Drawing 2 is the fixing chart of concave groove and convex ridge.

Drawing 3 is the fixing chart of snap fasteners.

Drawing 4 is the fixing chart of nylon agraffe.

In drawing, 1 indicates hair, 2 indicates head form, 3 indicates fixing part, 4 indicates bottom support, 5 indicates concave groove, 6 indicates convex ridge, 7 indicates snap fasteners, 8 indicates nylon agraffe.

As shown in Drawing 1, hair (1) connects to head form (2) by fixing part (3), head form (2) connects with bottom support (4). The fixing sets mentioned here may be either concave groove (5) and convex ridge (6) in Drawing 2, or snap fasteners (7) in Drawing 3, or nylon agraffe (8) in Drawing 4.

1-5. (canceled)

6. An apparatus for haircut teaching comprising:
a head form including a first fixing part disposed along a hairline;
a hair wig including a second fixing part corresponding to the first fixing part; and
a support disposed at a bottom end of the head form.

7. The apparatus of claim 6, wherein the first fixing part comprises a concave groove along the hairline.

8. The apparatus of claim 7, wherein the second fixing part comprise a convex ridge along the hairline.

9. The apparatus of claim 6, wherein the first fixing part comprises a first plurality of snap fasteners along the hairline.

10. The apparatus of claim 9, wherein the second fixing part comprises a second plurality of snap fasteners along the hairline.

11. The apparatus of claim 10, wherein the first plurality of snap fasteners corresponds to the second plurality of snap fasteners.

12. The apparatus of claim 6, wherein the first fixing part comprises a first piece of agraffe along the hairline.

13. The apparatus of claim 12, wherein the second fixing part comprises a second piece of agraffe along the hairline.

14. The apparatus of claim 13, wherein the first piece of agraffe corresponds to the second piece of agraffe.

15. The apparatus of claim 6, wherein the head form is made of poly vinyl chloride (PVC).
